(19) United States
(12) Patent Application Publication
(10) Pub. No.: US 2007/0082181 A1
(43) Pub. Date: Apr. 12, 2007

(54) CUSHIONING MATERIAL FOR PACKING

(76) Inventor: Woon-Tae Jung, Seoul (KR)

Correspondence Address: IPLA P.A., 3580 WILSHIRE BLVD., 17TH FLOOR, LOS ANGELES, CA, 90010, US

(21) Appl. No.: 11/531,476

(22) Filed: Sep. 13, 2006

(30) Foreign Application Priority Data
Oct. 10, 2005 (KR) 10-2005-0095054

(51) Int. Cl. B32B 3/28

(52) U.S. Cl. 428/182; 428/174

(57) ABSTRACT

Disclosed herein is a cushioning material for packing an object, such as an electrical product, kitchen utensils, an industrial machine, etc., to protect it from outside shocks. In the cushioning material of the present invention, embossments defining spaces are formed in a synthetic resin film constituting the cushioning material, and porous elastic balls are provided in the respective spaces. Thus, the cushioning material of the present invention can be wound in a roll shape while the elastic balls are pressed and reduced in volume. Therefore, a large amount of cushioning material can be loaded when being carried, thereby logistics costs are markedly reduced. Furthermore, the cushioning material of the present invention may be received in a roll casing such that a user can easily handle the cushioning material.

### CROSS REFERENCE

Applicant claims foreign priority under Paris Convention and 35 U.S.C. § 119 to a Korean Patent Application No. 10-2005-0095054, filed Oct. 10, 2005 with the Korean Intellectual Property Office.

### BACKGROUND OF THE INVENTION

1. Field of the Invention

The present invention relates generally to cushioning materials made of synthetic resin films and used for packing objects, such as electrical products, kitchen utensils, industrial machines, etc., to protect them from outside shocks and, more particularly, to a cushioning material for packing, in which a plurality of spaces is formed in a synthetic resin film and porous elastic balls are provided in respective spaces, so that, when the cushioning material is carried, it is reduced in volume by being pressed, and, when the cushioning material is used, the elastic balls, which have been pressed, are expanded and thus serve as cushions, and which may be wound in a roll shape and received in a roll casing, such that a user can conveniently cut and use a desired length of cushioning material.

2. Description of the Related Art

As shown in FIG. 1, a typical cushioning material 100 for packing includes a synthetic resin film 111, which consists of two layers and has a plurality of spaces 140, which are filled with air and defined between the two layers, so as to have an embossed structure. The spaces 140 are sealed by welding portions of the two layers around the spaces 140 to each other.

The conventional embossed cushioning material having the spaces charged with air has advantages in that superior cushioning ability is ensured and it is soft. However, because embossments defining the spaces charged with air are relatively fragile, they are easily broken by outside impact, so that the cushioning material may not be able to serve its intended function. Furthermore, when the cushioning material is wound in a roll shape to be stored or carried, because the volume thereof is relatively large due to the embossments defining the spaces filled with air, logistics costs are increased, and it is inconvenient to treat it.

In addition, because the conventional cushioning material made of a synthetic resin film is marketed in a wound state in a roll shape, when a user uses the cushioning material, a desired length is cut and, thereafter, the remaining cushioning material must be tied using a separately provided string.

Here, if the cushioning material is undesirably unwound due to the carelessness of the user, the user must again wind the cushioning material into a roll. As such, the conventional cushioning material is problematic in that it is inconvenient to the user and thus reduces workability.

### SUMMARY OF THE INVENTION

Accordingly, the present invention has been made keeping in mind the above problems occurring in the prior art, and an object of the present invention is to provide a cushioning material for packing in which porous elastic balls are provided in respective spaces which are formed in a synthetic resin film constituting the cushioning material, so that, when the cushioning material is wound in a roll shape, the porous elastic balls are pressed and the cushioning material is reduced in volume, thus a large amount of cushioning materials can be loaded to be carried, thereby logistics costs are markedly reduced.

In order to accomplish the above object, the present invention provides a cushioning material for packing, including a synthetic resin film having an upper layer and a lower layer, with embossments formed in the synthetic resin film by forming spaces between the upper layer and the lower layer of the synthetic resin film and by heat-welding portions of the upper and lower layers, surrounding the spaces, to each other. A porous elastic ball is provided in each of the spaces defined in the embossments.

Preferably, a through hole, communicating with each space having the elastic ball therein, may be formed at a predetermined position around each space through the upper or lower layer of the synthetic resin film.

Furthermore, the porous elastic ball may comprise a plurality of small elastic balls provided in each of the spaces.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a conventional air cushioning material for packing;

FIG. 2a is a sectional view of a cushioning material having porous elastic balls therein, according to an embodiment of the present invention;

FIG. 2b is a sectional view showing the shape of the cushioning material of FIG. 2a when it is pressed;

FIG. 3 is a partially exploded perspective view showing a roll casing, in which the cushioning material according to the present invention is provided;

FIG. 4 is a sectional view showing the roll casing of FIG. 3;

FIG. 5a is a sectional view of a cushioning material having porous elastic balls therein, according to another embodiment of the present invention;

FIG. 5b is a sectional view showing the shape of the cushioning material of FIG. 5a when it is pressed; and

FIG. 6 is a perspective view showing a roll of cushioning material having porous elastic balls according to the present invention.

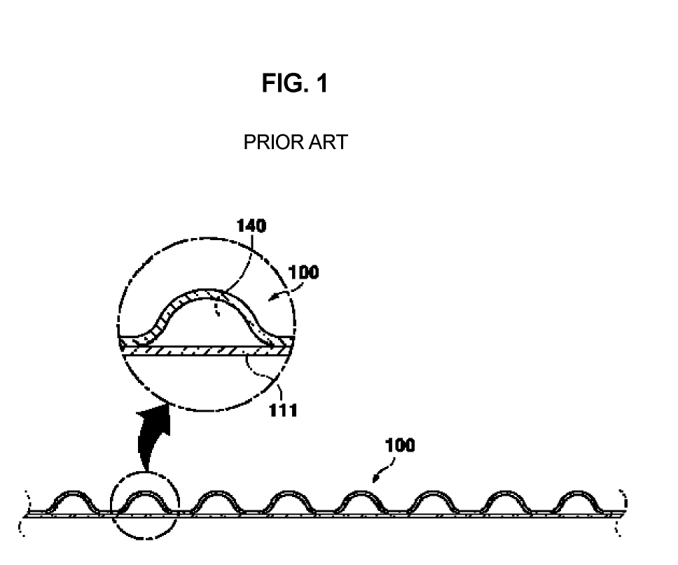

### DESCRIPTION OF THE PREFERRED EMBODIMENTS

Hereinafter, preferred embodiments of the present invention will be described in detail with reference to the attached drawings.

In a cushioning material 10 according to an embodiment of the present invention, a plurality of spaces 14 is formed in a synthetic resin film 11, so that the outer surface of the cushioning material is embossed.

In detail, the spaces 14, which form the embossments, are defined between an upper layer 12 and a lower layer 13 constituting the synthetic resin film 11. A porous elastic ball 20, for example, an EPP (expanded poly propylene) ball or an EPS (expanded poly styrene) ball, is placed in each space 14, and the upper layer 12 and lower layer 13 are welded by heating around the circumferential outer edges of the spaces 14, such that the porous elastic balls 20 can serve as cushions.

Furthermore, each space 14 communicates with outside air through a through hole 15, which is formed at a predetermined position around the space 14 in the synthetic resin film 11.

Meanwhile, a plurality of small porous elastic balls may be provided in each space 14.

The cushioning material 10 of the present invention having the above-mention structure may be received in a box-shaped roll casing 30, which has a plurality of guide rollers 31 therein, after being pressed and wound in a roll shape.

The box-shaped roll casing 30 has an outlet 32 in one surface thereof. A cutting tool 33 is provided under the outlet 32 such that the cushioning material 10 can be easily cut by the cutting tool 33.

The roll casing 30 is not a critical element of the present invention but will also be explained for the sake of clear comprehension of the present invention.

The roll casing 30 may be constructed such that the part provided above the outlet 32 is openable like a lid. In the case of a large roll casing 30, an openable door is preferably formed in one end of the roll casing 30 such that a cushioning material 10 can be installed in a horizontal direction. The lid, which is provided at an upper position, or the door, which is provided on one end of the roll casing 30, has a structure that is well known in the art, therefore further explanation is deemed unnecessary.

Meanwhile, to manufacture the cushioning material 10 of the present invention, the upper layer 12 and the lower layer 13 of the synthetic resin film 11 overlap each other and are pressed and adhered to each other by heating while a plurality of spaces 14 is formed in the synthetic resin film 11.

In detail, the upper layer 12 and the lower layer 13 are unwound from the respective rollers and, thereafter, a forming roller, which is disposed at a predetermined position, presses the upper layer 12 such that the spaces 14 are formed between the upper and lower layers 12 and 13. Subsequently, the upper and lower layers 12 and 13 are moved and hot-pressed by a hot press. Here, after the upper layer 12 is pressed to form the spaces, a separate elastic ball supply machine supplies porous elastic balls 20 in the respective spaces 14. Thereafter, the upper and lower layers 12 and 13 are hot-pressed at positions around the spaces 14 by the hot press.

In the above process, depending on the method of manufacturing the cushioning material, liquid resin may be supplied as the material of the upper and lower layers 12 and 13 of the cushioning material.

After the cushioning material has been completed, the cushioning material is pressed by a pressing roller, such that the porous elastic balls 20 provided in the spaces 14 are flattened. Thereafter, the cushioning material is wound in a roll shape and is inserted into the roll casing 30.

The synthetic resin film for the cushioning material of the present invention is the same as that of a typical cushioning material.

Meanwhile, the roll casing 30 has a hexahedral box shape. The guide rollers 31 are provided on the four respective inner surfaces of the roll casing 30 to support the outer surface of the roll of cushioning material 10, which is received in the roll casing 30.

The guide rollers 31, which are provided on the inner surfaces of the roll casing 30, serve to support the cushioning material 10, which is rotatably fitted over a support shaft 34, such that the porous elastic balls 20, which are placed in the spaces 14 of the synthetic resin film 11, can maintain the compressed state without expanding into ball shapes, and such that, when the end of the cushioning material 10 is pulled out through the outlet 32 of the roll casing 30, the roll of cushioning material 10 can be smoothly rotated.

The opposite ends of each guide roller are supported by a pair of support pieces, which are provided on each inner surface of the roll casing 30. Here, the diameters of support holes of the support pieces, in which the respective opposite ends of the guide roller are inserted, are greater than the diameters of the opposite ends of the guide roller, so that clearance is ensured therebetween, and the guide roller can be elastically moved in a radial direction of the roll of cushioning material in the support holes of the support pieces. Therefore, even if the cushioning material 10, which is fitted over the support shaft 34, increases in volume while being used, because the guide rollers 31 support the roll of cushioning material 10 when it is rotated, the cushioning material 10 can be smoothly extracted outside through the outlet 32.

Furthermore, the cutting tool 33 is provided under the outlet 32 on the outer surface of the roll casing 30, so that the cushioning material 10 can be easily cut by the cutting tool 33.

Meanwhile, because the elastic ball 20, which is placed in each space 14 of the synthetic resin film 11, is porous, when predetermined force is applied to the elastic ball 20, the elastic ball 20 is flattened, that is, is reduced in volume. When the force is removed, the elastic ball 20 is elastically returned to the initial state thereof.

Therefore, when the cushioning material 10 is wound in a roll shape, if the cushioning material 10 is wound after the elastic balls 20, which are placed in the respective spaces 14 of the synthetic resin film, have been pressed by the pressing roller such that the thicknesses thereof are reduced to 50%, the volume of the rolled cushioning material 10 is reduced to ¼ the volume of a conventional rolled cushioning material, the spaces of which are fully filled with air. Thus, the cushioning material 10 of the present invention is advantageous in that the volume thereof is markedly reduced when wound in a roll shape, compared to that of the conventional cushioning material, so that logistics costs are reduced. In other word, there is an advantage in that, when each elastic ball 20 is reduced in thickness by only 50%, the volume of the roll of cushioning material is reduced to ¼ of its original volume.

Furthermore, when each elastic ball 20, which is placed in each space 14 of the synthetic resin film, is flattened by being pressed, air in the space 14 is discharged outside through the through hole 15. When the elastic ball 20 is returned to the initial size thereof, air is drawn into the space 14 through the through hole 15.

As such, it is preferable that the through hole 15, which communicates with each space 14, be formed to smoothly contract and expand the elastic ball 20, which is placed in the space 14. However, as required, no through hole may be formed around the space 14 in which the elastic ball 20 is placed. The intended purpose of the present invention is also achieved by this case.

Furthermore, when the cushioning material 10 of the present invention is received in the roll casing 30 after being pressed to 50% of its original thickness and being wound in a roll shape, the guide rollers 31, which are provided in four directions in the roll casing 30, support the outer surface of the roll of cushioning material 10, thus maintaining the elastic balls 20 in the pressed state.

In the above state, in which the roll of cushioning material 10 is received in the roll casing 30, when a user pulls the outer end of the cushioning material 10 to discharge a desired length thereof outside through the outlet 32 and cuts it using the cutting tool 33, the diameter of the roll of cushioning material 10 is reduced, so that the outer surface of the roll is instantaneously spaced apart from the guide rollers 31, but the elastic balls 20, which are placed in the spaces 14 positioned at the outermost positions of the roll, are returned to the original sizes thereof, thereby the roll of cushioning material 10 is again supported by the guide rollers 31.

Furthermore, as the cushioning material 10 is used, when the diameter of the roll of cushioning material 10 is reduced to a predetermined extent, the roll of cushioning material 10 is no longer supported by the guide rollers 31. However, in this state, even if the elastic balls 20 in the spaces 14 are returned to the original sizes thereof, the roll of cushioning material 10 can freely rotate in the roll casing 30, thus the user is able to use it without inconvenience.

The roll casing 30 may be changed in size depending on the length of the cushioning material 10. Preferably, the roll casing 30 is made of one selected from metal, nonferrous metals, synthetic resin or paper.

Furthermore, the presence of the support shaft 34, which is longitudinally installed at a center position in the roll casing 30, is selectively determined depending on the size of the roll casing 30.

If the piece of cushioning material 10 is relatively long, so that the roll of cushioning material 10 is relatively large, a relatively large roll casing 30 is used. If the roll of cushioning material 10 is relatively small, a relatively small roll casing 30 is used. As such, the roll casing 30 is preferably manufactured in various sizes depending on the standard sizes of the roll of cushioning material 10.

In the case of a large roll casing 30, the support shaft 34 is installed in the roll casing 30, and the cushioning material 10 is fitted over the support shaft 34. Thus, when it is desired to use the cushioning material 10, the cushioning material 10 can be easily discharged thanks to the support of both the guide rollers 31, which correspond to the outer surface of the roll of cushioning material 10, and the support shaft 34, which is longitudinally provided in the roll casing 30.

In the case in which the roll of cushioning material 10 is relatively small, only the guide rollers 31 are provided in the roll casing 30, and the support shaft 34 is not installed, but there is still no difficulty in discharging the cushioning material 10.

Meanwhile, the cutting tool 33, which is provided under the outlet 32 on the roll casing 30 to cut the cushioning material 10, is made of metal or plastic. The cutting tool 33 is satisfactory as long as it is able to cut the cushioning material 10.

Furthermore, the cutting tool 33 is mounted to the roll casing 30 using a well known mounting method, such as a riveting method, a bolt coupling method, etc.

In the present invention, in the case of a roll casing 30 having no support shaft, a portion of the roll casing 30 above the outlet 32 serves as an openable lid, so that a cushioning material 10 is received in the roll casing 30 through the lid without a support shaft. In the case of a large roll casing 30, a door is provided on one end of the roll casing 30, so that a cushioning material 10 is fitted over the support shaft 34 in a horizontal direction.

In another embodiment of the present invention, a plurality of small elastic balls may be provided in each space 14 of a cushioning material 10 for packing.

In this embodiment, when the cushioning material 10 is manufactured, a plurality of small elastic balls, each having a diameter ranging from 1 mm to 5 mm, is provided in each space 14, unlike the former embodiment, in which one elastic ball is provided in each space 14 of the cushioning material 10.

Hereinafter, the drawings attached to the present invention will be explained in brief.

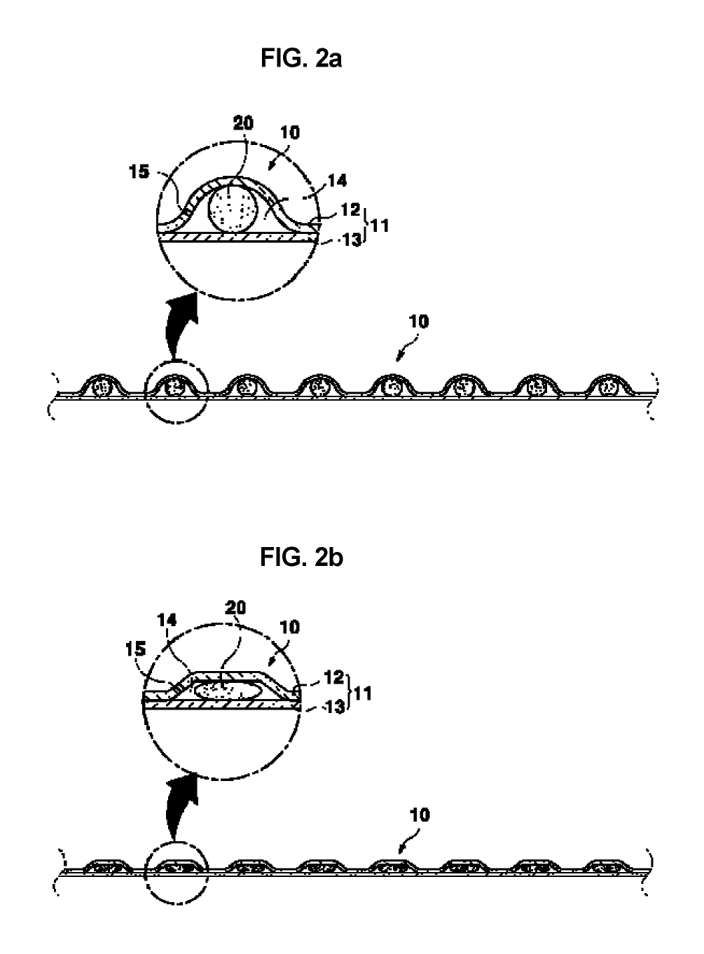

FIG. 2a is an illustrative view showing the cushioning material 10, in which protrusions for forming the spaces 14 are formed in one direction and the elastic balls 20 are provided in the respective spaces 14, showing the state in which the elastic balls 20 that are placed in the spaces 14 of the cushioning material 10 maintain sphere shapes, for example, when the cushioning material 10 is first manufactured, or when the elastic balls are returned to the original shapes thereof after having been pressed.

FIG. 2b is an illustrative view showing the state in which the cushioning material 10 of FIG. 2a having the elastic balls 20 is pressed, showing the state in which the elastic balls 20 in the spaces 14 are pressed by the pressing roller such that the thickness thereof is reduced to 50%, for example, in order to market the cushioning material 10.

Here, when the elastic balls 20 are contracted or expanded in the spaces 14, air in the spaces 14 is discharged outside or is drawn into the spaces 14 through the through holes 15, which are formed around the respective spaces 14 in the synthetic resin film 11.

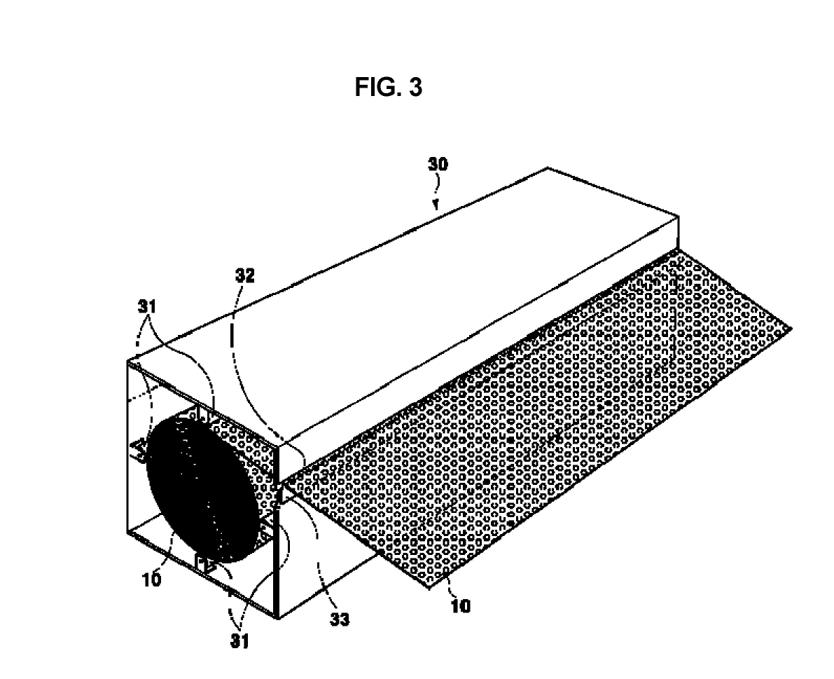

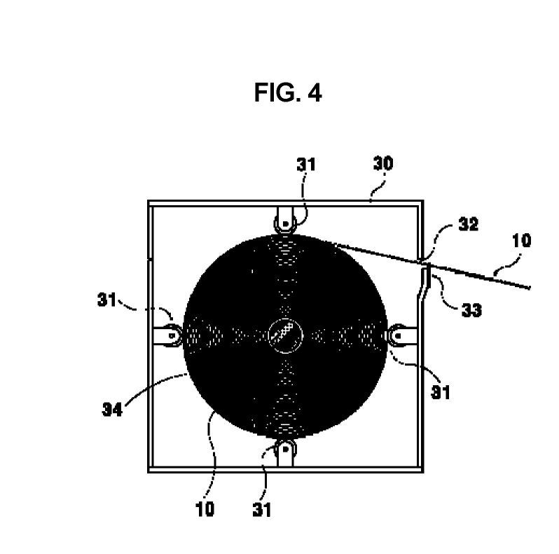

FIG. 3 is a partially exploded perspective view showing the roll casing 30, in which the cushioning material 10 is provided. FIG. 4 is a sectional view showing the roll casing 30 of the present invention, and showing the cushioning material 10, which is pressed such that the thickness of the elastic balls 20, which are provided in the respective spaces 14 formed in the cushioning material 10, is reduced by 50%, and is received in the roll casing 30 after being wound in a roll shape.

At this time, the cushioning material 10 is supported by the guide rollers 31, which are provided on the four respective inner surfaces of the roll casing 30, such that it can be smoothly extracted outside through the outlet 32 of the roll casing 30.

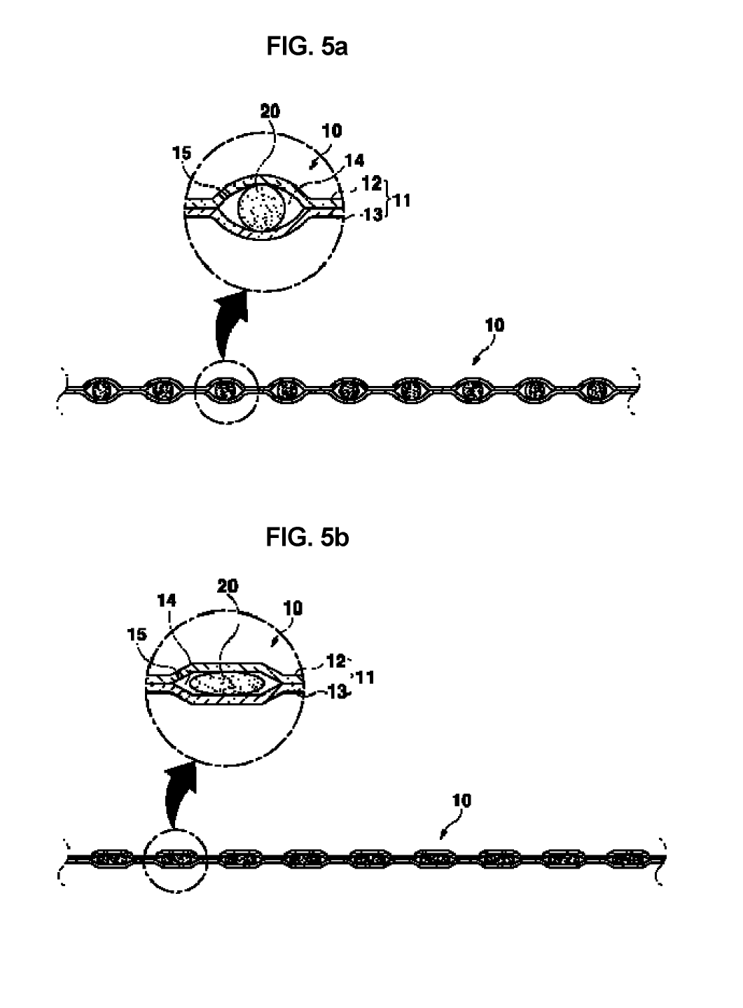

FIG. 5a is an illustrative view showing the cushioning material 10 for packing according to the present invention, in which protrusions for forming spaces 14 are formed in opposite directions. FIG. 5b is an illustrative view showing a pressed state of the cushioning material 10 of FIG. 5a having the elastic balls. That is, FIGS. 5a and 5b are illustrative views of the case, in which the spaces 14 protrude in opposite directions. The operation and effect of the cushioning material 10 of FIGS. 5a and 5b are equal to those of the cushioning material 10 of FIGS. 4a and 4b.

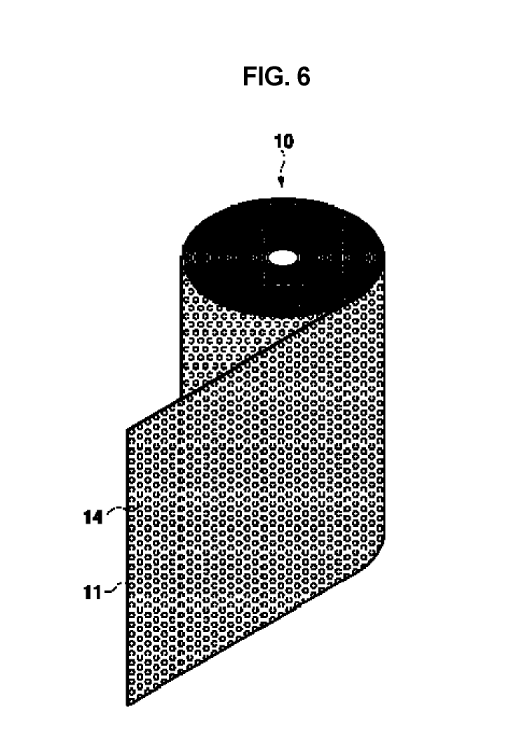

FIG. 6 is an illustrative view showing a roll of cushioning material 10 having porous elastic balls 20 according to the present invention, showing the cushioning material 10 wound in a roll shape after being pressed. Here, the cushioning material 10, which is wound in a roll shape, may be received in the roll casing 30, or may be packed using a vinyl sheet. In the case in which the user uses the cushioning material 10 in small amounts, the cushioning material 10 is preferably received in the roll casing 30. In the case in which a large amount of cushioning material 10 is used at one time, for example, at a construction site, the cushioning material 10, which is wound in a roll shape after being pressed, is packed by a vinyl sheet, a synthetic resin warp, a fabric sheet, or a paper sheet, and is supplied to the desired place.

That is, even though the cushioning material 10, which is wound in a roll shape, is wrapped with a vinyl sheet, the elastic balls can maintain the pressed state as long as the cushioning material 10 is not unwound. At a site, a large amount of cushioning material must be used at one time. In the case of the cushioning material 10, which is received in the roll casing 30, because the speed at which the cushioning material 10 is unwound is relatively slow, it is inefficient. Therefore, at a construction site, the cushioning material 10, which is wrapped with a vinyl sheet so that it can be easily used after the vinyl sheet has been cut, can be used.

As such, in the present invention having the above-mentioned structure, because the cushioning material can be reduced in volume by being pressed, a large amount of cushioning material can be loaded for transport. Furthermore, there are advantages in that the cushioning material of the present invention is stronger than and has increased shock absorption ability compared to conventional cushioning material having air caps.

As described above, in the cushioning material of the present invention, porous elastic balls are provided in respective spaces, which are formed in a synthetic resin film. Thus, when the cushioning material is wound in a roll shape, the volume thereof can be reduced to ¼ by being pressed, so that a large amount of cushioning material can be loaded for transport, and a large amount of cushioning material can be stored, compared to the conventional art. Thereby, logistics costs and storage costs are reduced. Particularly, in the conventional art, the cushioning material must be stood upright when stored, but, in present invention, because the cushioning material is contained in the roll casing, it can be stored in a vertical or horizontal orientation, that is, it can be selectively oriented depending on the conditions of cargo or conditions in a transport vehicle.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A cushioning material for packing, comprising: a synthetic resin film having an upper layer and a lower layer, with embossments formed in the synthetic resin film by forming spaces between the upper layer and the lower layer of the synthetic resin film and by heat-welding portions of the upper and lower layers, surrounding the spaces, to each other, wherein
a porous elastic ball is provided in each of the spaces defined in the embossments.

2. The cushioning material as set forth in claim 1, wherein a through hole, communicating with each space having the elastic ball therein, is formed at a predetermined position around each space through the upper or lower layer of the synthetic resin film.

3. The cushioning material as set forth in claim 1, wherein the porous elastic ball comprises a plurality of small elastic balls provided in each of the spaces.
